(19) United States
(12) Patent Application Publication
(10) Pub. No.: US 2006/0144299 A1
(43) Pub. Date: Jul. 6, 2006

(54) Method for reducing autogeneous shrinkage of super high strength concrete

(76) Inventors: Kazunori Takada, Tokyo (JP); Shuji Yanai, Tokyo (JP); Toshimichi Ichinomiya, Tokyo (JP); Takahiro Watanabe, Tokyo (JP); Yoshihiro Hishiki, Tokyo (JP); Yukihiko Morita, Tokyo (JP); Yohei Taira, Tokyo (JP); Hiroshi Kasai, Tokyo (JP)

Correspondence Address: CLARK & BRODY, 1090 VERMONT AVENUE, NW, SUITE 250, WASHINGTON, DC, 20005, US

(21) Appl. No.: 10/563,231

(22) PCT Filed: Jun. 29, 2004
(86) PCT No.: PCT/JP04/09509

§ 371 Date: Jan. 3, 2006

(30) Foreign Application Priority Data
Jul. 4, 2003 (JP) 2003-191784

(51) Int. Cl. C04B 24/36; C04B 20/00

(52) U.S. Cl. 106/672; 106/671

(57) ABSTRACT

A method is provided for reducing autogenous shrinkage in ultra high-strength concrete in the blending of ultra high-strength concrete with a compression strength in excess of 100 N/mm², comprising the steps of: replacing 30 vol. % or less of coarse aggregate with artificial lightweight aggregate, and blending in a expansive additive in the amount of 30 kg/m³ of concrete and/or a shrinkage reducing agent in the amount of 4 wt. % or less per unit weight of binder, and thereby bringing the amount of autogenous shrinkage at a curing age of 91 days to 0-600 μm/m. The artificial lightweight aggregate used has water absorption of 5% or greater and 20% or less, a collapse load of 1000-2000 N and a bone-dry density of 1.4-2.0 g/cm³.

### BACKGROUND OF THE INVENTION

1. Field of the Invention

The present invention relates to a method for reducing autogenous shrinkage in ultra high-strength concrete.

2. Background Art

Ultra high-strength concrete in the 100-150 N/mm² class has found practical application in the construction field (see Kenchiku Gijutsu [Construction Engineering], July 2002, pp. 184-188, pp. 189-193.). However, it has found virtually no practical application in the civil engineering field, but steel fiber-reinforced mortar with a compression strength of 200 N/mm² (mortar that comprises grains smaller than 2 mm and metal fibers, and that does not contain coarse aggregate) has recently found practical application in bridge beam structures that utilize precast members (e.g., Sakata Mirai Bridge in Yamagata Prefecture, Japan). However, although this special mortar has a high strength, its cost is also high. Concrete with a compression strength on the order of 100-150 N/mm² with a proven track record in the construction field undergoes large amounts of autogenous shrinkage and is thus not typically suited to large concrete structures in the civil engineering field.

### OBJECT OF THE INVENTION

Autogenous shrinkage of ultra high-strength concrete is the cause of cracks, reduced shear strength in precast concrete members, and reduced effective prestress when made into precast concrete members, so it is vital to reduce autogenous shrinkage as much as possible from the standpoints of both structural design and durability. However, ultra high-strength concrete with a compression strength of 150 N/mm² or greater may exhibit 400 μm/m or more of autogenous shrinkage at a curing age of 91 days, or in some cases 500 μm/m or more. For this reason, it is desirable to reduce the amount of autogenous shrinkage in ultra high-strength concrete economically and without compromising the target strength and workability. It is an object of the present invention to meet these demands.

### SUMMARY OF THE INVENTION

The present invention provides: a method for reducing autogenous shrinkage in ultra high-strength concrete in the blending of ultra high-strength concrete with a compression strength in excess of 100 N/mm², comprising the steps of: replacing 30 vol. % or less of coarse aggregate with artificial lightweight aggregate, and blending in an expansive additive in the amount of 30 kg/m³ of concrete and/or a shrinkage reducing agent in the amount of 4 wt. % or less per unit weight of binder, and thereby bringing the amount of autogenous shrinkage at a curing age of 91 days to 0-600 μm/m.

The artificial lightweight aggregate used preferably has water absorption of 5% or greater and 20% or less, a collapse load of 1000-2000 N and a bone-dry density of 1.4-2.0 g/cm³.

Into this ultra high-strength concrete may further be blended at least one of: a water reducing agent, a high-performance water reducing agent, an air-entraining water reducing agent or a high-performance air-entraining and water reducing agent according to JIS A 6204, “Chemical Admixtures for Concrete.”

The ratio of water to binder including cement (the water-binder ratio) is preferably 10-25% and the amount of coarse aggregate is preferably 0-400 L/m³. The binder including cement preferably comprises cement and silica fume.

### BRIEF EXPLANATION OF THE DRAWINGS

FIG. 1 is a graph of the slump flow of various examples of ultra high-strength concrete blends.

FIG. 2 is a graph of the times to start setting of various examples of ultra high-strength concrete blends.

FIG. 3 is a plot of the change over time in the compression strengths of ultra high-strength concrete upon blending in an expansive additive and/or shrinkage reducing agent.

FIG. 4 is a plot of the change over time in the compression strengths of ultra high-strength concrete upon blending in artificial lightweight aggregate.

FIG. 5 is a plot of the change over time in the compression strengths of ultra high-strength concrete upon blending in artificial lightweight aggregate and an expansive additive and/or shrinkage reducing agent.

FIG. 6 is a plot of the behavior of autogenous shrinkage strain in ultra high-strength concrete upon blending in an expansive additive and/or shrinkage reducing agent.

FIG. 7 is a plot of the behavior of autogenous shrinkage strain in ultra high-strength concrete upon blending in artificial lightweight aggregate.

FIG. 8 is a plot of the behavior of autogenous shrinkage strain in ultra high-strength concrete upon blending in artificial lightweight aggregate and an expansive additive and/or shrinkage reducing agent.

FIG. 9 is a plot of the relationship between autogenous shrinkage strain (autogenous length change) and the water absorption of coarse aggregate.

### DESCRIPTION OF THE PREFERRED EMBODIMENT

The subject of the present invention is to ultra high-strength concrete that exhibits compression strength (91-day compression strength) in excess of 100 N/mm², or further compression strength (91-day compression strength) in excess of 130 N/mm². Such ultra high-strength concrete can be manufactured by blending and mixing: water, binder including cement, fine aggregate, coarse aggregate smaller than a maximum dimension of 20 mm, and at least one of a water reducing agent, a high-performance water reducing agent, an air-entraining and water reducing agent or a high-performance air-entraining and water reducing agent according to JIS A 6204, “Chemical Admixtures for Concrete,” where the water-binder ratio is 10-25% and the amount of coarse aggregate is 0-400 L/m³. The binder including cement is defined to be a cement mixture containing Portland cement, pozzolan-based and slag-based admixtures, or one with an admixture of silica fume (also called silica fume cement).

With such ultra high-strength concrete, the present invention comprises the steps of: replacing 30 vol. % or less of said coarse aggregate with artificial lightweight aggregate, and blending in a expansive additive in the amount of 30 kg/m³ of concrete and/or a shrinkage reducing agent in the amount of 4 wt. % or less per unit weight of binder, and thereby bringing the amount of autogenous shrinkage at a curing age of 91 days to 0-600 μm/m.

The autogenous shrinkage of concrete is explained as a phenomenon that occurs by water within pore voids being consumed as the cement hydration reaction proceeds within the interior of the concrete, the water level moving to voids with even smaller pore diameters, thus increasing the capillary tension caused by the surface tension of water. The cause is the so-called phenomenon of “autogenous drying.” This is particularly marked in high-strength concrete that has a low water-cement ratio, and when silica fume or the like is used to make the texture denser, the capillary tension becomes even higher and the amount of shrinkage also increases.

Blending in appropriate amounts of artificial lightweight aggregate in accordance with the present invention has the effect of reducing this autogenous drying. The moisture retained by the artificial lightweight aggregate functions as a “reservoir” within the concrete, replenishing the moisture consumed by the hydration reaction and thus giving rise to a “self-curing effect” that reduces drying within the pore voids, so it is thus possible to reduce autogenous shrinkage and drying shrinkage.

The artificial lightweight aggregate used in the present invention preferably has water absorption of 5% or greater and 20% or less, a collapse load of 1000-2000 N and a bone-dry density of 1.4-2.0 g/cm³.

An example of a typical method of manufacturing such artificial lightweight aggregate is as follows. Take a coarse powder of coal ash (a) that is produced as a byproduct of coal-fired power plants and has the chemical composition given below and a fine powder of shale (b) that has the chemical composition given below, combine such that the weight ratio of (a):(b) is from 4:6 to 6:4, add a binder and granulate and then fire this in a rotary kiln at approximately 1100-1200° C., quenching in water starting from around 100-200° C. in the cooling process. The sinter product thus obtained can be crushed and classified into fine aggregate that is 5 mm or smaller and coarse aggregate that is 5-15 mm.

(a) Chemical analysis values (wt. %) of coal ash SiO₂: about 54%, Al₂O₃: about 29%, Fe₂O₃+FeO: about 4.5%, CaO: about 3.5%, MgO: about 1.0%, ignition residue: about 4.7%.

(b) Chemical analysis values (wt. %) of shale SiO₂: about 70%, Al₂O₃: about 13%, Fe₂O₃+FeO: about 4.2%, CaO: about 1.6%, MgO: about 1.6%, ignition residue: about 5.6%.

The 5-15 mm coarse aggregate thus obtained may exhibit, for example, bone-dry density=1.52 g/cm³, hot water absorption=15%, and a collapse load according to JIS Z 8841=1130 N. Here, the hot water absorption is defined to be the value of the water absorption measured in the surface-dry state at room temperature after a water-quench starting from 100-200° C. in the process of firing this artificial lightweight aggregate. This aggregate has nearly uniformly distributed porosity at pore radii of 50-6000 nm, and its cumulative porosity (total porosity) reaches approximately 110 m³/g. This acts effectively in contributing to increased strength while still maintaining a low specific gravity and increased moisture-retention performance. By selecting the raw materials and appropriately controlling the firing conditions in accordance with the same principle, it is possible to manufacture artificial lightweight aggregate that has a collapse load according to JIS Z 8841 of 1000-2000 N, a bone-dry density of 1.4-2.0 g/cm³ and a water absorption in the range of 5% or greater and 20% or less, and by using this artificial lightweight aggregate, it is possible to manufacture ultra high-strength concrete with low autogenous shrinkage.

If the collapse load of the artificial lightweight aggregate is less than 1000 N, then a concrete strength greater than 100 N/mm³ cannot be obtained, but conversely if the load is greater than 2000 N, adequate amounts of porosity cannot be obtained, so the water absorption will drop and thus it cannot contribute to reducing the autogenous shrinkage. Accordingly, the artificial lightweight aggregate used in the present invention has a collapse load of 1000-2000 N, preferably 1100-2000 N and more preferably 1200-1800 N. In addition, if the bone-dry density of the artificial lightweight aggregate is less than 1.4 g/cm³, then it is difficult to secure a collapse load of 1000 N or greater, but if this density exceeds 2.0 g/cm³, then it is difficult to secure adequate water absorption, so the artificial lightweight aggregate used in the present invention should have a bone-dry density of 1.4-2.0 g/cm³, or preferably 1.40-1.70 g/cm³. If the water absorption is below 5%, then the effect of reducing the autogenous shrinkage or drying shrinkage of the concrete does not adequately appear, but if it is in excess of 20%, it is difficult to secure a collapse load of 1000 N or greater at a density of 2.0 g/cm³ or less, so the artificial lightweight aggregate used in the present invention should have water absorption of 5% or greater and 20% or less, preferably 7-20% and more preferably 10-18%.

When the artificial lightweight aggregate is blended into ultra high-strength concrete, it is preferable that 30 vol. % or less of the amount of coarse aggregate blended in be replaced with this artificial lightweight aggregate. This is because if more than 30 vol. % of the coarse aggregate is replaced with artificial lightweight aggregate, then there is a risk that the ultra high-strength concentration would lose the properties it should have.

With the present invention, upon replacing a portion of the coarse aggregate with artificial lightweight aggregate in this manner, in order to further control autogenous shrinkage accurately and precisely, stipulated amounts of a expansive additive and/or shrinkage reducing agent are blended in. That is, upon blending in an appropriate amount of artificial lightweight aggregate, either a expansive additive or a shrinkage reducing agent may be blended in singly, or both the expansive additive and the shrinkage reducing agent may be blended in together.

The expansive additive used should preferably react with water to produce acicular crystals called ettringite, forming a texture coarser than that of the ordinary cement reaction products, thus swelling the concrete by taking advantage of the fact that the apparent volume thus produced becomes larger. Examples of such commercially available expansive additives include those with the trade names of Power CSA, Power CSA Type R, etc. made by Denki Kagaku Kogyo K.K. The amount of the expansive additive blended in should be no more than 30 kg/m³ of ultra high-strength concrete.

The shrinkage reducing agent should preferably be one that has the effect of reducing the capillary tension that is the cause of concrete shrinkage, or namely one that has the effect of reducing the surface tension of water in pores and thus has the effect of reducing autogenous shrinkage and drying shrinkage. Examples of such commercially available shrinkage reducing agents include those that have lower alcohol additives, for example, Tetraguard AS21 (trade name) made by Taiheiyo Material Corp. can be used. The amount of shrinkage reducing agent blended in should be no more than 4 wt. % per unit weight of the binder of the ultra high-strength concrete.

Materials that can be used as the binder in the ultra high-strength concrete according to the present invention include Portland cement as well as the following other binders, for example, silica fume, fly ash, coal gasification fly ash, fine powdered blast furnace slag and the like.

The chemical admixtures that can be used in the ultra high-strength concrete according to the present invention (at least one of a water reducing agent, high-performance water reducing agent, air-entraining and water reducing agent or a high-performance air-entraining and water reducing agent according to JIS A 6204) include: polycarbonate-based, polyether-based, naphthalene-based, melamine sulfonate-based, amino sulfonate-based and other ones, but polycarbonate-based or polyether-based ones are particularly preferable. In addition, an antifoaming agent can be used as an auxiliary agent.

Here follows a more detailed description of the method for reducing autogenous shrinkage in ultra high-strength concrete according to the present invention made with reference to representative examples of experiments performed by the present inventors.

### EXAMPLE 1

[Materials Used]

Cement: silica fume cement (density 3.08 g/cm³, specific surface area 4050 cm²/g)

Fine aggregate: crushed quartz schist sand from Danto (dry-surface density 2.62 g/cm³, water absorption 0.72%, fineness modulus 3.10)

Coarse aggregate: crushed quartz schist from Danto (maximum size 20 mm, dry-surface density 2.62 g/cm³, water absorption 0.57%, percentage of absolute volume 63.1%)

Chemical admixture: polycarbonate ether-based high-performance water reducing agent (trade name Mighty 3000TH2 made by Kao Corporation)

Artificial lightweight aggregate: coal ash-based artificial lightweight aggregate (trade name J Lite from Nihon Mesalite Co., Ltd.; grain size 5-10 mm, bone-dry density 1.40-1.60 g/cm³, water absorption 12.2%, collapse load 1100-1300 N)

Expansive additive: coal-ettringite-based expansive additive (density 3.02 g/cm³, specific surface area 3500 cm²/g; trade name Power CSA Type R of Denki Kagaku Kogyo K.K.)

Shrinkage reducing agent: lower alcohol additive (trade name Tetraguard AS21 made by Taiheiyo Material Corp.)

Table 1 presents the experiment standards and blending conditions for concrete. The symbols used in the table are as follows. W=water, C=silica fume cement, G=coarse aggregate, SP=high-performance water reducing agent, JL=artificial lightweight aggregate, EX=expansive additive, RA=shrinkage reducing agent. The experiments described below were performed for all 12 blends illustrated in Table 1.

TABLE 1

| | | | | G + JL | | | RA/ | JL/(G + JL) |
|---|---|---|---|---|---|---|---|---|
| | Air | W/(C + EX) | W | volume | SP/(C + EX) | EX | (C + EX) | volume |
| Blend name | (%) | (%) | (kg/m³) | (L/m³) | (%) | (kg/m³) | (%) | ratio (%) |
| Base blend | 1.5 | 17 | 155 | 300 | 1.5 | — | — | — |
| E20 | | | | | | 20 | — | — |
| E25 | | | | | | 25 | — | — |
| E30 | | | | | | 30 | — | — |
| R2 | | | | | | — | 2.0 | — |
| E25R2 | | | | | | 25 | 2.0 | — |
| JL10 | | | | | | — | — | 10 |
| JL20 | | | | | | — | — | 20 |
| JL30 | | | | | | — | — | 30 |
| JL20E10 | | | | | | 10 | — | 20 |
| JL20R1 | | | | | | — | 1.0 | 20 |
| JL20E10R05 | | | | | | 10 | 0.5 | 20 |

TABLE 2
(W includes the SP volume)

| | | Coarse | | Unit weight (kg/m³) | | | | |
|---|---|---|---|---|---|---|---|---|
| W/C | Air | aggregate | SP/C | | | Fine | Coarse | Admixture |
| (%) | (%) | volume (L/m³) | (%) | Water W | Cement C | aggregate S | aggregate G | SP |
| 17 | 1.5 | 300 | 1.5 | 155 | 912 | 613 | 798 | 13.7 |

[Experimental Method]

The concrete was mixed using a dual shaft forced concrete mixer (100 liter capacity, 60 rpm). The materials other than the coarse aggregate (including the artificial lightweight aggregate) were placed in the mixer and mixed for 120 seconds, the mixer was halted and then the cement adhering to the inside walls and blades was scraped and then the mixer was started up again and mixing was performed for 180 seconds. Then the coarse aggregate (including the artificial lightweight aggregate) was added, mixing was performed for 180 seconds and the concrete was discharged from the mixer. After mixing, the slump flow, air content and concrete temperature were measured immediately, and samples to be used for measuring the compression strength, setting time and autogenous shrinkage were prepared. The compression strength was measured based on JIS A 1108-1999 at curing ages of 7, 28, 56 and 91 days. The setting time was measured based on JIS A 1147-2001, but the measurement was done up until the starting time in order to know the time to the start of setting for measuring autogenous shrinkage. Autogenous shrinkage was measured based on the method of the JCI Autogenous Shrinkage Committee-1999, but the measurement of strain was performed by means of a low-rigidity type of embedded strain gage.

[Slump Flow and Setting Time]

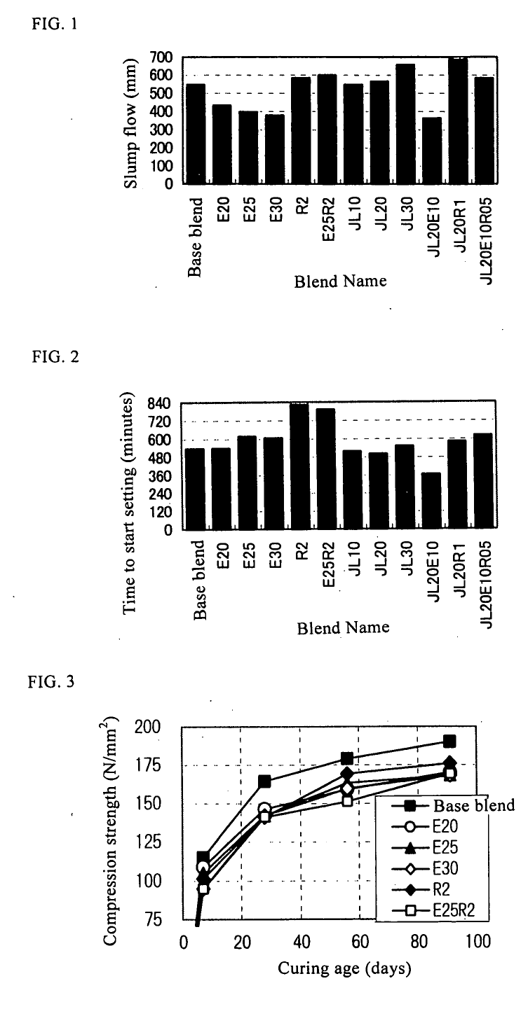

FIG. 1 is a graph of the slump flow of various blends. From the results of FIG. 1, one can see that the addition of an expansive additive tends to lower the slump flow, losing workability. Conversely, the shrinkage reducing agent is seen to have the effect of increasing the slump flow. The slump flow also exhibited a trend of increasing as the fraction replaced with artificial lightweight aggregate increased, so one can see that the workability is increased. Those blends with a slump flow of 550 mm or greater were determined to have good self-compacting properties. Note that the air content was adjusted to the range 1.3-2.5%.

FIG. 2 shows the results of measuring the times to start of setting of various blends. Note that when the expansive additive and artificial lightweight aggregate are used singly, there was no large difference in the time to the start of setting in comparison to the base blend. However, in the case when both of these were used (JL20E10), a result indicating a shorter time to start setting was obtained. In addition, the shrinkage reducing agent was clearly confirmed to have the effect of delaying setting.

[Compression Strength]

FIGS. 3-5 show the results of compression strength testing. The concrete with the base blend exhibited high compression strength of 164 N/mm² at a curing age of 28 days and 190 N/mm² at 91 days. From FIGS. 3-5 overall, one can say that in each of the cases intended to reduce autogenous shrinkage, the resulting compression strength was less than that of the base blend, but the target of a compression strength of 150 N/mm² or greater was achieved with all of the blends at a curing age of 56 days.

More specifically, FIG. 3 compares strength expression history in the cases of using the expansive additive or shrinkage reducing agent alone and when used together. In the cases when an expansive additive alone was used (E20, E25 and E30), the concrete exhibited lower strength at 7 days the greater the amount added, but the strengths were nearly identical after 28 days, reaching roughly 170 N/mm² at 91 days. In the case in which 2% shrinkage reducing agent was added (R2), the long-term strength was somewhat larger than in the case in which the expansive additive was used, becoming 176 N/mm² at a curing age of 91 days. In E25R2 where both the expansive additive and shrinkage reducing agent were used, the test results were somewhat low at a curing age of 56 days but at other ages, the strength history was nearly the same as that of E30.

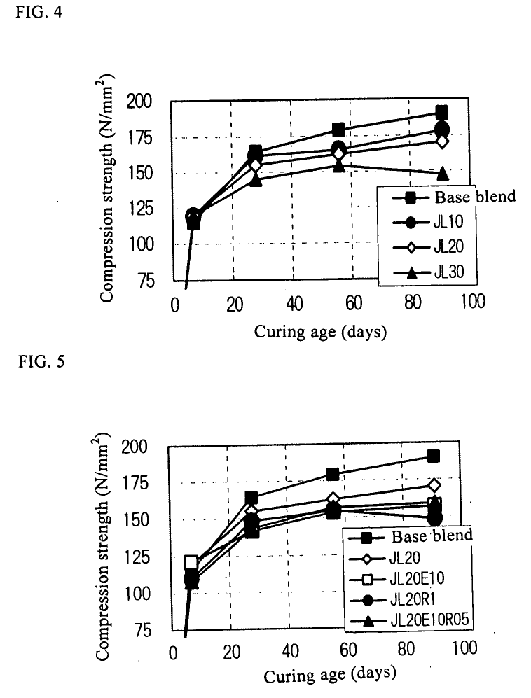

FIG. 4 illustrates the history of expression of compression strength as a function of the fraction of aggregate replaced with artificial lightweight aggregate. The compression strength was smaller the greater the fraction replaced at all curing ages, and in particular when 30% was replaced (JL30), the strength increased no further after a curing age of 28 days, becoming roughly flat at around 150 N/mm². However, when up to 20% was replaced, the compression strength was confirmed to increase up until a curing age of 91 days, reaching 170 N/mm² when 20% was replaced (JL20).

FIG. 5 illustrates the history of expression of compression strength when the fraction of aggregate replaced with artificial lightweight aggregate was kept constant at 20%, and furthermore the expansive additive and/or shrinkage reducing agent were used. Each of the blends resulted in reducing the compression strength in comparison to JL20, but the differences among JL20E10, JL20R1 and JL20E10R05 were small, with the strength increasing no further after a curing age of 56 days in all three cases. With these blends, compression strengths of roughly 149-155 N/mm² were obtained at a curing age of 91 days.

[Autogenous Shrinkage]

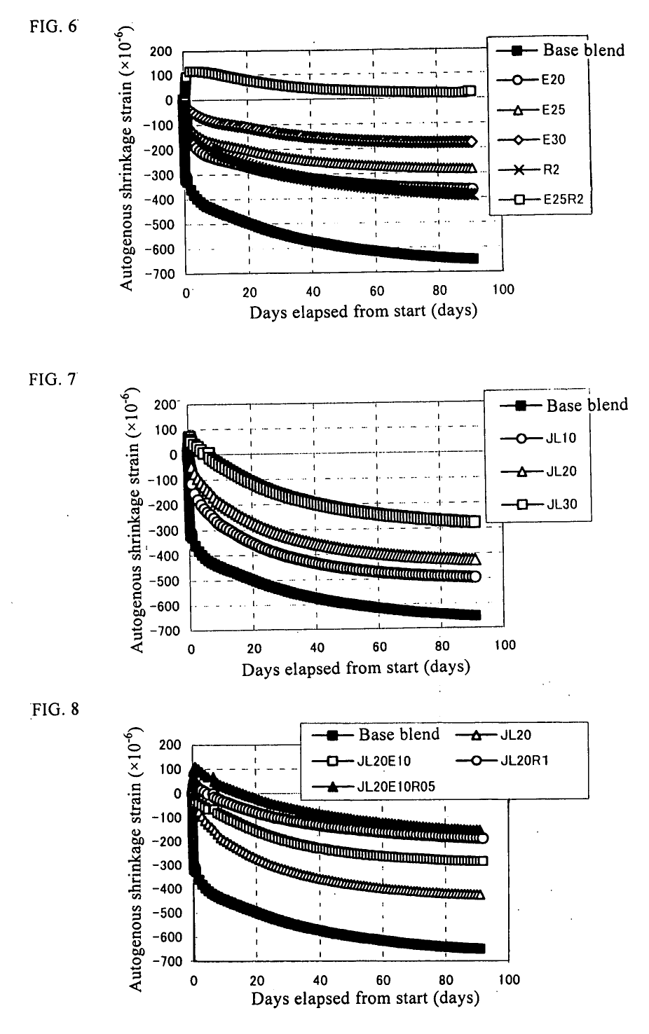

FIGS. 6-8 show the results of measuring autogenous shrinkage. In the case of each of the blends, the strain at the time of the start of setting is taken to be 0, and the free shrinkage (expansion) strain is measured at the 20° C. non-dried state thereafter. A large autogenous shrinkage value of 650 μm/m was measured at a curing age of 91 days in the concrete with the base blend (▪).

FIG. 6 shows the change over time in autogenous shrinkage when an expansive additive and/or shrinkage reducing agent was used, illustrating that when 20 kg/m³ of expansive additive was used (E20), the autogenous shrinkage was 370 μm/m or 40% less than that of the base blend. As the amount added was increased, the reducing effect also increased, reaching 180 μm/m (curing age of 91 days) when 30 kg/m³ was used (E30), thus exhibiting the effect of reduction by 70% or more. In the case in which 2% shrinkage reducing agent was added (R2), the effect of shrinkage reduction was roughly the same (40%) as that of the case of 20 kg/m³ expansive additive (E20). In the case in which both 25 kg/m³ of expansive additive and 2% of shrinkage reducing agent were used (E25R2), an effect in excess of the additive effect of using the two singly was exhibited, so after expansion of 110 μm/m was found in the early in curing, the amount of expansion gradually decreased until the curing age of 91 days.

FIG. 7 shows the change over time in autogenous shrinkage as a function of the fraction of aggregate replaced with artificial lightweight aggregate, with the percent reduction at a curing age of 91 days being 24% (JL10), 34% (JL20) and 57% (JL30), respectively, so one can see that the effect of reducing autogenous shrinkage is increased as the fraction replaced becomes higher.

The results from Example 1 can be summarized as follows.

(1) With the base blend, although high compression strength of 190 N/mm² is exhibited at a curing age of 91 days, 650 μm/m of autogenous shrinkage occurs.

(2) The addition of 20-30 kg/m³ expansive additive is highly effective in reducing shrinkage, but workability drops.

(3) The addition of 2% shrinkage reducing agent is highly effective in reducing shrinkage but workability does not drop.

(4) The use of both 25 kg/m³ expansive additive and 2% shrinkage reducing agent can bring autogenous shrinkage to zero.

(5) Artificial lightweight aggregate can reduce autogenous shrinkage commensurate with the fraction of the coarse aggregate replaced, but the drop in strength is also commensurate with the fraction replaced.

(6) If the fraction replaced with artificial lightweight aggregate is set to a maximum of 20 vol. %, and small amounts of a expansive additive and/or shrinkage reducing agent are used together, the shrinkage can be very effectively reduced at a relatively low cost.

### EXAMPLE 2

This experiment was carried out to examine the effect that the water absorption of artificial lightweight aggregate has on the autogenous shrinkage of concrete.

[Materials Used]

Cement: low-heat Portland cement (symbol L) (made by Sumitomo Osaka Cement Co., Ltd.; density 3.22 g/cm³)

Fine aggregate: land sand (from Shizuoka; dry-surface density 2.62 g/cm³, water absorption 1.38%)

Coarse aggregate:
(1) Natural aggregate (symbol N): (crushed stone from Okutama; dry-surface density 2.65 g/cm³, water absorption 0.50%)
(2) Artificial lightweight aggregate (symbol J): (trade name J Lite from Nihon Mesalite Co., Ltd.; bone-dry density 1.41 g/cm³, water absorption adjusted to 5%, 10% or 12.5%)
(3) Artificial lightweight aggregate (symbol M): (trade name Mesalite from Nihon Mesalite Co., Ltd.; bone-dry density 1.29 g/cm³, water absorption 28%)

Chemical admixture: high-performance air-entraining and water reducing agent (trade name Pozzolith SP8SBs)

Water: tap water from Chofu City

Table 3 presents the concrete blends (Runs No. 1-5). The symbols used for each run indicate the materials above; for example, LJ-5% indicates that low-heat Portland cement was used and J Lite with water absorption of 5% was used as the coarse aggregate.

TABLE 3

| | | | | | | | | | High-performance |
|---|---|---|---|---|---|---|---|---|---|
| | | | | Air | | | | | AE and water- |
| Run | | W/C | S/A | volume | W | C | S | G | reducing agent |
| No. | Symbol | (%) | (%) | (%) | (kg/m³) | (kg/m³) | (kg/m³) | (kg/m³) | (C × %) |
| 1 | LJ-5% | 30 | 45 | 3 | 170 | 567 | 736 | 484 | C × 10 |
| 2 | LJ-10% | | | | | | | 484 | C × 10 |
| 3 | LJ-12.5% | | | | | | | 484 | C × 09 |
| 4 | LM-28% | | | | | | | 442 | C × 09 |
| 5 | LN-0.5% | | | | | | | 909 | C × 11 |

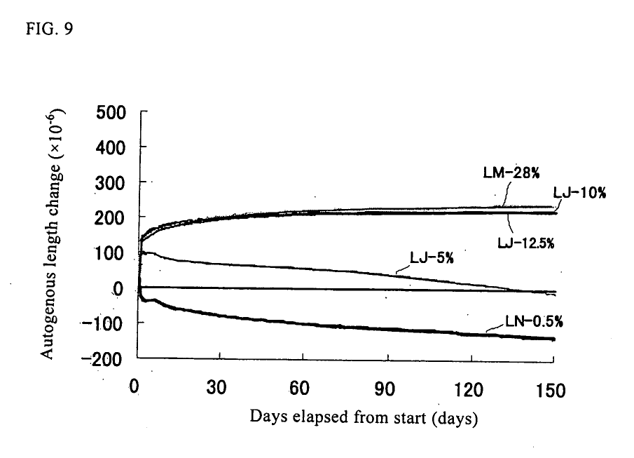

The various blends of concrete were mixed and samples to be used for measuring autogenous shrinkage were prepared in the same manner as in Example 1, and the autogenous shrinkage was measured in the same manner as in Example 1. The results are given in FIG. 9.

As seen in FIG. 9, concrete made with natural aggregate having 0.5% water absorption exhibits autogenous shrinkage. In the case of using J Lite having 5% water absorption, the autogenous length change was in the negative direction, so the effect of reducing autogenous shrinkage is not seen. In contrast, when J Lite having 10% or 12.5% water absorption was used, the autogenous length change was in the positive direction, thus exhibiting the effect of reducing autogenous shrinkage. When Mesalite having 28% water absorption was used, in the same manner as with the J Lite with 10% water absorption, the autogenous length change was roughly +200 μm and increased no further.

As described above, with the present invention, it is possible to reduce the amount of autogenous shrinkage in ultra high-strength concrete economically and without compromising the target strength and workability. It is thus possible to apply ultra high-strength concrete to the civil engineering field, and the problem of reduced effective prestress when made into precast concrete members is also solved.

1. A method for reducing autogenous shrinkage in ultra high-strength concrete in the blending of ultra high-strength concrete with a compression strength in excess of 100 N/mm², comprising the steps of:
replacing 30 vol. % or less of coarse aggregate with artificial lightweight aggregate, and
blending in a expansive additive in the amount of 30 kg/m³ of concrete and/or a shrinkage reducing agent in the amount of 4 wt. % or less per unit weight of binder, and thereby
bringing the amount of autogenous shrinkage at a curing age of 91 days to 0-600 μm/m.

2. The method for reducing autogenous shrinkage in ultra high-strength concrete according to claim 1, wherein the artificial lightweight aggregate used has water absorption of 5% or greater and 20% or less, a collapse load of 1000-2000 N and a bone-dry density of 1.4-2.0 g/cm³.

3. The method for reducing autogenous shrinkage in ultra high-strength concrete according to claim 1, further comprising a step of blending into the ultra high-strength concrete at least one of: a water reducing agent, a high-performance water reducing agent, an air-entraining and water reducing agent or a high-performance air-entraining and water-reducing agent according to JIS A 6204, “Chemical Admixtures for Concrete.”

4. The method for reducing autogenous shrinkage in ultra high-strength concrete according to claim 1, wherein the ratio of water to binder including cement (the water-binder ratio) is 10-25% and the amount of coarse aggregate is 0-400 L/m³.

5. The method for reducing autogenous shrinkage in ultra high-strength concrete according to claim 2, further comprising a step of blending into the ultra high-strength concrete at least one of: a water reducing agent, a high-performance water reducing agent, an air-entraining and water reducing agent or a high-performance air-entraining and water-reducing agent according to JIS A 6204, “Chemical Admixtures for Concrete.”

6. The method for reducing autogenous shrinkage in ultra high-strength concrete according to claim 2, wherein the ratio of water to binder including cement (the water-binder ratio) is 10-25% and the amount of coarse aggregate is 0-400 L/m³.

7. The method for reducing autogenous shrinkage in ultra high-strength concrete according to claim 3, wherein the ratio of water to binder including cement (the water-binder ratio) is 10-25% and the amount of coarse aggregate is 0-400 L/m³.
